(19) United States
(12) Patent Application Publication
(10) Pub. No.: US 2015/0144433 A1
(43) Pub. Date: May 28, 2015

(54) METHOD FOR INSTALLING ROPES OF AN ELEVATOR AND A PULLEY ARRANGEMENT OF AN ELEVATOR

(71) Applicants: Johannes KOIVUKANGAS, Vantaa (FI); Tommi RAUTIO, Hyvinkaa (FI)

(72) Inventors: Johannes KOIVUKANGAS, Vantaa (FI); Tommi RAUTIO, Hyvinkaa (FI)

(73) Assignee: Kone Corporation, Helsinki (FI)

(21) Appl. No.: 14/526,647

(22) Filed: Oct. 29, 2014

(30) Foreign Application Priority Data
Nov. 27, 2013 (EP) 13194591

(51) Int. Cl. B66B 15/02; B66B 19/02

(52) U.S. Cl. CPC B66B 15/02; B66B 19/02
USPC 187/266; 29/428; 29/402.08

(57) ABSTRACT

The invention relates to a method for installing one or more ropes of an elevator, wherein a pulley of a pulley arrangement is roped, which pulley arrangement comprises a pulley having a shaft for mounting it rotatably on a support frame, the shaft having a first end and a second end; and a support frame having a first supporting wall and a second supporting wall spaced apart and having a pulley space between them, in which pulley space the pulley is mounted, the first end of the shaft extending into a first opening of the first supporting wall, and the second end of the shaft extending into a second opening of the second supporting wall. In which method one or more ropes is/are guided to pass around said pulley. The method comprises steps wherein a free space is arranged on the axial side of the pulley and the second end of the shaft sufficiently large to allow a rope to be moved transversely past the axial side of the pulley and the second end of the shaft in the pulley space, said step comprising at least enabling axial movement of the shaft, and thereafter moving the shaft axially so that the second end of the shaft retracts from the second opening, into the pulley space; and thereafter said rope(s) is/are moved in the transverse direction thereof in the pulley space past the axial side of the pulley and the second end of the shaft; and thereafter the shaft is moved axially so that the second end of the shaft penetrates back into the second opening; and thereafter the shaft is fixed at least axially immovable. The invention relates also to a pulley arrangement of an elevator.

This application claims priority to European Patent Application No. EP13194591 filed on Nov. 27, 2013, the entire contents of which are incorporated herein by reference.

### FIELD OF THE INVENTION

The invention relates to a method for installing one or more ropes of an elevator, as well as to a pulley arrangement of an elevator, which elevator is of the type meant for vertically transporting passengers and/or goods.

### BACKGROUND OF THE INVENTION

Pulleys of elevators are typically mounted in a pulley space delimited by supporting walls formed by a pulley frame, which pulley frame is fixedly mounted on a mounting space, e.g. a counterweight. The pulley is supported on the frame via a shaft having its one end supported by one of the supporting walls and the other end by the other of the supporting walls. In existing pulley arrangements and methods for roping elevator pulleys the ropes are designed to be installed by first dismantling the frame, and then guiding the ropes to pass around said pulley. In particular, one of the supporting walls has been detached from the pulley frame so as to make room for the ropes. The problem of these known arrangements and methods has been that the dismantling as well as the subsequent reassembling of the pulley frame structure has been time consuming. Also, detachability of the aforementioned parts of the frame, which are amongst the most essential bearing parts of the frame, has required a specific, often robust and possibly complex structure so as to ensure reliable fixing.

### BRIEF DESCRIPTION OF THE INVENTION

The object of the invention is, inter alia, to solve one or more of the previously described drawbacks of known solutions and problems discussed later in the description of the invention. An object of the invention is to introduce a new method for installing one or more ropes of an elevator as well as a pulley arrangement implementing the method. Embodiments are presented, inter alia, where the installation time can be saved. Embodiments are presented, inter alia, where dismantling of the components of the pulley arrangement of the elevator need not involve detaching of the most essential bearing parts of the pulley frame.

It is brought forward a new method for installing one or more ropes of an elevator, wherein a pulley of a pulley arrangement is roped, which pulley arrangement comprises a pulley having a shaft for mounting it rotatably on a support frame, the shaft having a first end and a second end. The pulley arrangement comprises a support frame having a first supporting wall and a second supporting wall spaced apart and having a pulley space between them, in which pulley space the pulley is mounted, in particular the first end of the shaft supported on the first wall and the second end supported on the second wall, the pulley thereby being mounted via the shaft. The first end of the shaft extends into a first opening of the first supporting wall, and the second end of the shaft extends into a second opening of the second supporting wall. In the method one or more ropes is/are guided to pass around the circumference of said pulley. In the method a free space is arranged on the axial side of the pulley and on the axial side of the second end of the shaft sufficiently large to allow a rope to be moved transversely past the axial side of the pulley and past the axial side of the second end of the shaft in the pulley space, said step comprising at least enabling axial movement of the shaft, in particular by releasing a fixing means for fixing the shaft at least axially immovable, which fixing means are releasable to allow axial movement of the shaft. Thereafter the shaft is moved axially (towards a first axial direction) so that the second end of the shaft retracts from the second opening into the pulley space, in particular so that the first end of the shaft penetrating deeper into the first opening. Thereafter, said rope(s) is/are moved in the transverse direction thereof in the pulley space past the axial side of the pulley and past the axial side of the second end of the shaft. Thereafter, the shaft is moved axially (towards a second axial direction, which is opposite to the first direction), so that the second end of the shaft penetrates back into the second opening. Thereafter, the shaft is fixed at least axially immovable. In this way, the process of rope installation, and possibly also a process of rope replacement including a process of rope installation, is simple as well as quick to perform. In particular, the process of rope installation is possible to be performed efficiently also in the shaft environment. Furthermore, in this way the process of rope installation need not involve detaching of the most essential bearing parts of the pulley frame. Thus, safety of the method can be facilitated. This aspect also makes it easier to design the pulley frame to have a simple structure.

In a preferred embodiment, said one or more ropes is/are guided to pass around said pulley while the pulley arrangement already forms part of a counterweight mounted in the elevator. In this context, the arrangement and the method are most advantageous.

In a preferred embodiment, said one or more rope is/are guided to pass around said pulley while the pulley frame is already mounted on or integral with the counterweight frame.

In a preferred embodiment, the method is a method for replacing old ropes of an existing (already in use) elevator, which method further comprises a step wherein the old rope(s) is/are moved in the transverse direction thereof (i.e. sideways relative to the longitudinal direction of the rope) in the pulley space past the axial side of the pulley and past the axial side of the second end of the shaft away from the pulley space.

In a preferred embodiment, the fixing means comprise at least one blocking member blocking the second end of the shaft from moving axially (towards the first axial direction) so that the second end of the shaft retracts from the second opening into the pulley space, which at least one blocking member is movable into an unblocking position, and in the method the fixing means are released to allow axial movement of the shaft (towards the first axial direction) by moving the at least one blocking member into an unblocking position, e.g. by displacing preferably detaching, the at least one blocking member from the second end of the shaft.

In a preferred embodiment, the arrangement comprise means for blocking the pulley from moving axially in the pulley space, which means comprise around the second end of the shaft a bushing, one axial end of the bushing being supported in axial direction against an inner cylinder part of the bearing and the other axial end extending into the second opening, the axial movement of the bushing (in the second direction) through the second opening being blocked by a blocking member of the fixing means, the bushing thereby blocking the inner cylinder part and thereby also the pulley body from moving axially towards the second supporting wall, the blocking member being movable into an unblocking state, e.g. by detaching it, and when the blocking member is in the unblocking state the bushing can be moved through said second opening out of the pulley space, and in the method the blocking member is moved into the unblocking state, after which the bushing is moved through said second opening out of the pulley space, whereby the bushing is moved out of way of the rope(s).

It is also brought forward a new pulley arrangement of an elevator which pulley arrangement comprises a pulley having a shaft for mounting it rotatably on a support frame, the shaft having a first end and a second end, and a support frame having a first supporting wall and a second supporting wall spaced apart and having a pulley space between them, in which pulley space the pulley is mounted. In particular, the first end of the shaft is supported on the first wall and the second end supported on the second wall, the pulley thereby being mounted via the shaft. The first end of the shaft extends into (and through) a first opening of the first supporting wall, and the second end of the shaft extending into (and through) a second opening of the second supporting wall. The pulley arrangement further comprises fixing means for fixing the shaft at least axially immovable, which fixing means are releasable to allow axial movement of the shaft. When the fixing means are in released state the shaft is axially movable in the first and second opening such that the second end of the shaft retracts from the second opening into the pulley space such that a free space is formed on the axial side of the second end of the shaft sufficiently large to allow a rope to be moved transversely past the axial side of the second end of the shaft in the pulley space. In particular, the shaft is movable axially towards a first axial direction such that the first end of the shaft penetrates deeper into the first opening and the shaft retracts from the second opening into the pulley space in the defined manner. Thus, the rope(s) can be moved past the by the shaft of the pulley in the pulley space unblocked by the shaft. Hereby, the process of rope installation need not involve detaching of the most essential bearing parts of the pulley frame, in particular detaching of large portions or even the complete supporting walls can be avoided. As a result, efficiency and simplicity of the process of rope installation, and possibly also a process of rope replacement including a process of rope installation, can be facilitated. Thus, also safety of the rope installation process can be facilitated. This aspect also makes it easier to design the pulley frame to have a simple structure.

In a preferred embodiment, the arrangement is (at least partly thanks to the defined axial movability of the shaft) bringable into a state where a free space exists on the axial side of the pulley and on the axial side of the second end of the shaft sufficiently large to allow a rope to be moved transversely past the axial side of the pulley and past the axial side of the second end of the shaft in the pulley space. In a preferred embodiment, the pulley arrangement has, or at least is bringable to have, a free space on the axial side of the pulley sufficiently large to allow a rope to be moved transversely past the axial side of the pulley in the pulley space. The arrangement is then at least partly thanks to this feature bringable into said state.

In a preferred embodiment, the fixing means comprise at least one blocking member, preferably on the second end of the shaft, for blocking the second end of the shaft from moving axially (towards the first axial direction) so that the second end of the shaft retracts from the second opening into the pulley space, which at least one blocking member is movable into an unblocking position so as to release the fixing means to allow axial movement of the shaft, e.g. by detaching the at least one blocking member from the second end of the shaft.

In a preferred embodiment, the fixing means comprise a blocking member, preferably on the first end of the shaft, for blocking the first end of the shaft from moving axially (towards the second axial direction) so that the first end of the shaft retracts from the first opening into the pulley space.

In a preferred embodiment, the fixing means comprises a blocking member mounted on the second supporting wall for blocking rotation of the shaft, preferably a displaceable (e.g. detachable) blocking member for blocking rotation of the shaft, which blocking member is displaceably (e.g. detachably) mounted on the second supporting wall.

In a preferred embodiment, the pulley comprises a bearing via which the pulley body is supported on the shaft.

In a preferred embodiment, the bearing has an outer cylinder part in fixed connection with the pulley body and an inner cylinder part rotatable within the outer cylinder part inside on which inner cylinder part the shaft is mounted.

In a preferred embodiment, the pulley arrangement comprises a means for blocking the pulley from moving axially in the pulley space.

In a preferred embodiment, said means for blocking the pulley from moving axially in the pulley space comprise around the second end of the shaft a bushing, one axial end of the bushing being supported in axial direction against an inner cylinder part of the bearing and the other axial end extending into the second opening, the axial movement of the bushing in the second direction through the second opening being blocked by a blocking member of the fixing means, the bushing thereby blocking the inner cylinder part and thereby also the pulley body from moving axially towards the second supporting wall, the blocking member being movable into an unblocking state, e.g. by detaching it, and when the blocking member is in the unblocking state the bushing can be moved through said second opening out of the pulley space, whereby the bushing can be moved out of way of the rope(s).

In a preferred embodiment, said means for blocking the pulley from moving axially in the pulley space comprise around the first end of the shaft a bushing one axial end of the bushing being supported against an inner cylinder part of the bearing and the other axial end extending into the first opening, the axial movement of the bushing (in the first direction) through the first opening being blocked by a blocking member of the fixing means whereby the inner cylinder part and thereby the pulley body is blocked from moving axially towards the first supporting wall.

In a preferred embodiment, the shaft is movably back toward the second axial direction so that the second end of the shaft penetrates back into the second opening, until the shaft is in position where its first end of the shaft extends into the first opening of the first supporting wall, and the second end of the shaft extends into the second opening of the second supporting wall.

In a preferred embodiment, the shaft extends through an opening of the pulley. It is preferable, but not necessary, that shaft is axially movable relative to the pulley in said the opening. This movability provides that the shaft can be moved a long way axially in the first and second opening, independently of how great a clearance there is between the pulley and the first supporting wall. As one advantage, the second end of the shaft can extend through and well beyond the second opening, if desired. The pulley, in particular the inner part of the bearing, is then preferably mounted on the shaft axially movably and positioned axially by a means for blocking the pulley from moving axially in the pulley space.

The elevator as described anywhere above is preferably, but not necessarily, installed inside a building. It is of the type where the car is arranged to serve two or more landings. The car preferably responds to calls from landing and/or destination commands from inside the car so as to serve persons on the landing(s) and/or inside the elevator car. Preferably, the car has an interior space suitable for receiving a passenger or passengers, and the car can be provided with a door for forming a closed interior space. Thereby, it is well suitable for serving passengers.

### BRIEF DESCRIPTION OF THE DRAWINGS

In the following, the present invention will be described in more detail by way of example and with reference to the attached drawings, in which

FIG. 1 illustrates a sectional view of a first embodiment of a pulley arrangement.

FIGS. 2 to 4 illustrate side views of the pulley arrangement of FIG. 1 at subsequent stages of a method according to a first embodiment for installing ropes to pass around the pulley of a pulley arrangement.

FIG. 5 illustrates a sectional view of a second embodiment of a pulley arrangement.

FIGS. 6 to 8 illustrate side views of the pulley arrangement of FIG. 5 at subsequent stages of a method according to a second embodiment for installing ropes to pass around the pulley of a pulley arrangement.

FIGS. 9a-11b illustrate further preferable details of the pulley arrangement as well as the method.

### DETAILED DESCRIPTION

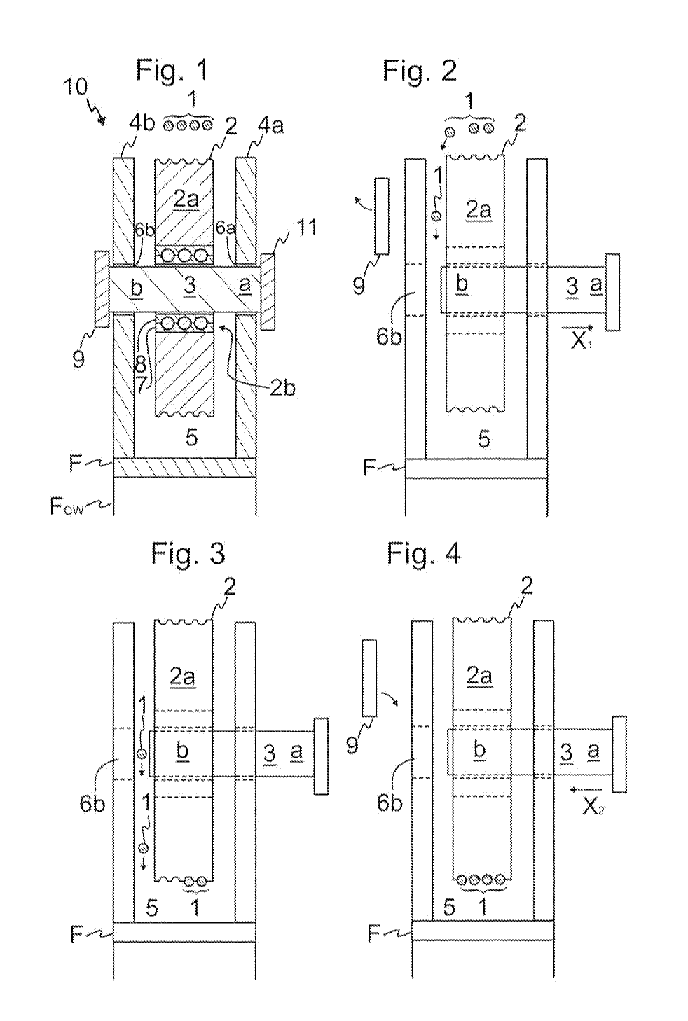

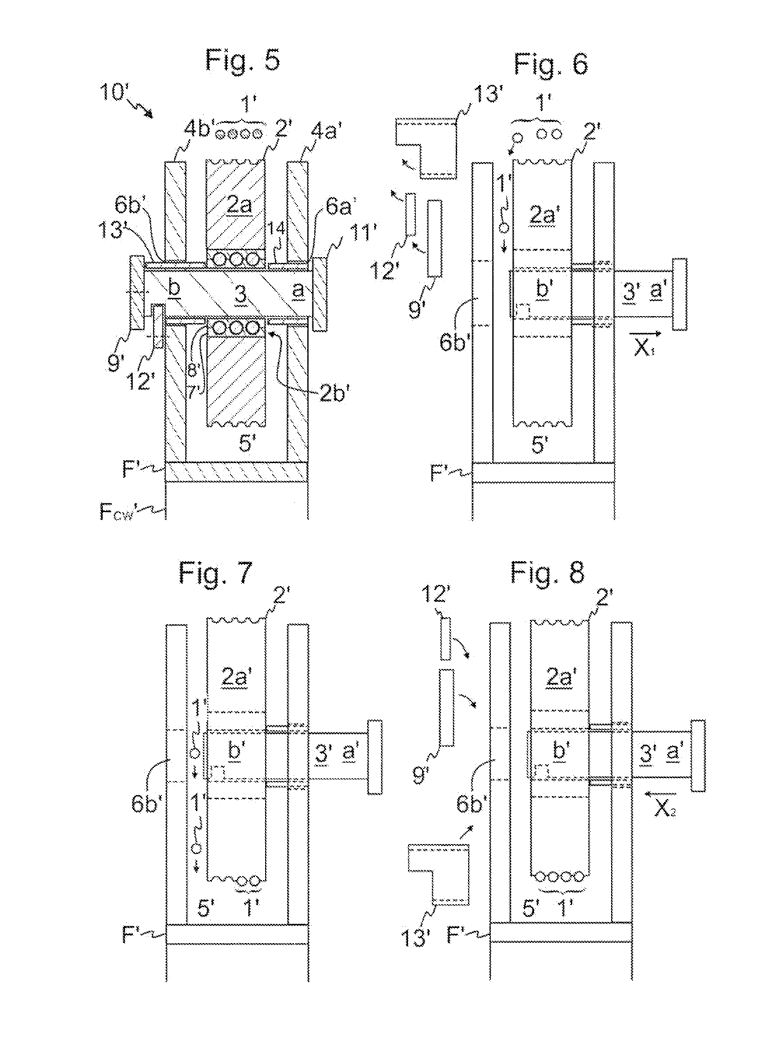

FIGS. 1 to 4 illustrate a first embodiment of a pulley arrangement 10 according to a first embodiment of the invention at subsequent stages of a method for installing ropes 1 to pass around the pulley 2 of a pulley arrangement 10. Correspondingly, FIGS. 5 to 8 illustrate a pulley arrangement 10′ according to a second embodiment of the invention at subsequent stages of a method for installing one or more ropes 1 to pass around the pulley 2 of a pulley arrangement 10.

Referring to FIGS. 1 and 5, wherein the pulley arrangement 10,10 is illustrated in its assembled state prior the installing of ropes 1,1′ therein, each of the pulley arrangements 10,10′ comprises a support frame F,F′, and a rope pulley 2,2′ suitable for receiving a rope 1,1′ around its circumference. The rope pulley 2,2′ (also referred to as pulley) has a shaft 3,3′ for mounting it rotatably on the support frame F,F′, which shaft 3,3′ has a first end a,a′ and a second end b,b′. The support frame F,F′ has a first supporting wall 4a,4a′ and a second supporting wall 4b,4b′ spaced apart and having a pulley space 5,5′ between them, in which pulley space 5,5′ the pulley 5,5′ is mounted, the first end a,a′ of the shaft 3,3′ supported on the first supporting wall 4a,4a′ and the second end b,b′ supported on the second wall 4b,4b′ the pulley thereby being mounted via the shaft 3,3′. The first end a,a′ of the shaft 3,3′ extends into, a first opening 6a,6a′ of the first supporting wall 4a,4a′ and through it. The second end b,b′ of the shaft 3,3′ extends into a second opening 6b,6b′ of the second supporting wall 4b,4b′ and through it. The arrangement 10,10′ further comprises a fixing means 9,11,12;9′, 11′,12′ for fixing the shaft 3,3′ at least axially immovable, which fixing means 9,11,12;9′,11′,12′ can be released to allow axial movement of the shaft 3,3′.

The pulley 2,2′ being meant to rotate relative to the supporting walls 4a,4b;4a′,4b′, there is inherently a clearance between the axial side of pulley 2,2′, and the second supporting wall 4b,4b′. This clearance can in the method be utilized for moving the rope(s) 1,1′ past the axial side of the pulley 2,2′. The pulley arrangement 10,10′ has (thanks to said clearance), or at least is bringable to have, a free space on the axial side of the pulley 2,2′ sufficiently large to allow a rope 1,1′ to be moved transversely past the axial side of the pulley 2,2′ in the pulley space 5,5′. However, the rope(s) 1,1′ cannot be moved completely around the pulley 2,2′ in the pulley space 5,5′ because the shaft 2,2′ is in the way. To circumvent this, the shaft 3,3′ is designed to be moved out of the way of the rope(s) 1,1′. For this purpose, when the fixing means 9,11;9′,11′,12′ are in a released state, as illustrated in FIGS. 2 and 7 respectively, the shaft 3,3′ is axially movable in the first and second opening 6b,6b such that the shaft 3,3′ moves axially towards a first axial direction X₁ so that the first end of the shaft 3,3′ penetrates deeper into the first opening 6a,6a′ and the second end b,b′ of the shaft 3,3′ retracts from the second opening into the pulley space 5,5′ such that a free space is formed on the axial side of the second end b,b′ of the shaft 3,3′ sufficiently large to allow a rope 1,1′ to be moved transversely past the axial side of the second end b,b′ of the shaft 3,3′ in the pulley space 5,5′. The arrangement 10,10′ is, at least partly thanks to this feature, bringable into a state where a free space exists on the axial side of the pulley 2,2′ and the second end b,b′ of the shaft 3,3′, which free space is sufficiently large to allow a rope 1,1′ to be moved transversely past the axial side of the pulley 2,2′ and past the axial side of the second end b,b′ of the shaft 3,3′ in the pulley space 5,5′. Thereby, the rope(s) 1,1′ can be moved in the transverse direction thereof (i.e. sideways relative to the longitudinal direction of the rope 1,1′) in the pulley space 5,5′ the second end b,b′ of the shaft 3,3′ and past the axial side of the pulley 2,2′ and further to pass around said pulley 2,2′ turning against and around its circumference, as illustrated in FIGS. 3 and 7. So as to restore the pulley arrangement 10,10′ back to its assembled state after guiding the ropes 1 past the axial side of the second end b,b′ of the shaft 3,3′, the shaft 3,3′ is, as illustrated in FIGS. 2 and 7 respectively, axially movable back toward the second axial direction X₂ so that the second end b,b′ of the shaft 3,3′ penetrates back into the second opening 6b,6b′, until the shaft 3,3′ is in its original position, i.e. in the position where its first end a,a′ extends into the first opening 6,6a′ of the first supporting wall 4a,4a′, and the second end b,b′ extends into the second opening 6b,6b′ of the second supporting wall 4b,4b′.

In the method for installing one or more ropes 1,1′ of an elevator, starting from the situation as illustrated in FIGS. 1 and 5 respectively, the pulley arrangement 10,10′ is brought into a state where a free space exists on the axial side of the pulley 2,2′ and the second end b,b′ of the shaft 3,3′ sufficiently large to allow a rope 1,1′ to be moved transversely past the axial side of the pulley 2,2′ and past the axial side of the second end b,b′ of the shaft 3,3′ in the pulley space 5,5′. In bringing the arrangement 10,10′ into such state, at first axial movement of the shaft 3,3′ in a first axial direction X₁ is enabled, in particular by releasing the aforementioned fixing means 9,11,12;9′,11′,12′ to allow axial movement of the shaft 3,3′ into first axial direction X₁. After this, the shaft 3,3′ is moved axially towards the first axial direction X₁ so that the first end a,a′ of the shaft 3,3′ penetrates deeper into the first opening 6a,6a′ and the second end b,b′ of the shaft 3,3′ retracts from the second opening 6b,6b′ into the pulley space 5,5′ between the supporting walls. This stage is illustrated in FIGS. 2 and 6 respectively. After this, each rope 1,1′ to be installed around the pulley 2 is/are moved in the transverse direction thereof (i.e. sideways relative to its longitudinal direction) in the pulley space 5,5′ past the axial side of the pulley 2,2′ and past the axial side of the second end b,b′ of the shaft 3,3′. This stage is illustrated in FIGS. 3 and 7 respectively. The method is carried out without moving the shaft completely through the first opening 6a,6a′. In particular, the pulley 2,2′ is maintained mounted on shaft 3,3′ between the supporting walls 4a,4b;4a′,4b′ when the rope(s) 1,1′ is/are guided past the axial side of the second end b,b′ of the shaft 3,3′ in the pulley space 5,5′. After moving the rope(s) 1,1′ at least past the axial side of the second end b,b′ of the shaft 3,3′, the shaft 3,3′ is moved, as illustrated in FIGS. 3 and 7 respectively, axially towards a second axial direction X₂, which is opposite to the first direction X₁, so that the second end b,b′ of the shaft 3,3′ penetrates back into the second opening 6b,6b′. Thereafter, the shaft 3,3′ is fixed at least axially immovable with the fixing means 9,11;9′,11′,12′. At a suitable moment after the ropes 1 are guided past the axial side of the second end b,b′ of the shaft 3,3′, they are further guided to pass around said pulley 2,2′, in particular such that they turn against and around its circumference.

It is preferable, that the pulley comprises a bearing 2b,2b′ via which the pulley body 2a,2a′ is supported on the shaft 3,3′. As illustrated in FIGS. 1-8, the bearing 2b,2b′ has an outer cylinder part 7,7′ in fixed connection with the pulley body 2a,2a′ and an inner cylinder part 8,8′ rotatable within the outer cylinder part 7,7′ inside which inner cylinder part 8,8′ the shaft 3,3′ is mounted. The pulley 2,2′ is in particular an idle pulley.

In the first embodiment, as illustrated in FIGS. 1-4, said fixing means 9,11 comprise a blocking member 9 mounted (e.g. with a bolt, not showed) on the second end b of the shaft 3,3′ for blocking the second end b of the shaft 3 from moving axially towards the first axial direction X₁ so that the second end b of the shaft 3 retracts from the second opening 6b into the pulley space 5. The blocking member 9 is movable into an unblocking position so as to release the fixing means 9,11 to allow axial movement of the shaft 3 in the first direction X₁. In this embodiment, the blocking member 9 is an end plate forming an extension radially protruding from the shaft 3 so that the shaft 3 cannot fit to move through the second opening 6a when the blocking member is mounted on the shaft 3. The blocking member 9 is movable to unblocking position by detaching it from the second end a of the shaft 3, in this case by opening the bolt or other suitable means (not showed) fixing it to the end face of the shaft 3. Said fixing means 9,11 also comprise a blocking member 11 on the first end a of the shaft 3 blocking the first end a of the shaft 3 from moving axially towards the second axial direction X₂ so that the first end a of the shaft retracts from the first opening 6a into the pulley space 5. In this embodiment, the blocking member 11 is an end plate forming an extension radially protruding from the shaft 3 so that the shaft 3 cannot fit to move through the first opening 6a. The blocking member may be detachable but this is not necessary.

In the second embodiment, as illustrated in FIGS. 5-8, the pulley arrangement 10′ is otherwise similar to the pulley arrangement 10 of the first embodiment, but it comprises additionally at the second end b of the shaft 3′ a means 13′,14′ for blocking the pulley 2′ from moving axially in the pulley space 5, as well as a blocking member 12′ for blocking rotation of the shaft 3′.

In the second embodiment, the fixing means 9′,11′,12′ comprise a blocking member 9′ mounted (e.g. with a bolt, not showed) on the second end b′ of the shaft 3′ for blocking the second end b′ of the shaft 3′ from moving axially towards the first axial direction X₁ so that the second end b′ of the shaft 3′ retracts from the second opening 6b′ into the pulley space 5′. The blocking member 9′ is movable into an unblocking position so as to release the fixing means 9′,11′,12′ to allow axial movement of the shaft 3 in the first direction X₁. In this embodiment, the blocking member 9′ is an end plate forming an extension radially protruding from the shaft 3′ so that the shaft 3′ cannot fit to move through the second opening 6a when the blocking member is mounted on the shaft 3′. The blocking member 9′ is movable to unblocking position by detaching it from the second end a of the shaft 3′, in this case by opening the bolt or other suitable means (not showed) fixing it to the end face of the shaft 3′. Said fixing means 9′,11′,12′ also comprise a blocking member 11′ on the first end a′ of the shaft 3′ blocking the first end a of the shaft 3′ from moving axially towards the second axial direction X₂ so that the first end a of the shaft retracts from the first opening 6a′ into the pulley space 5′. In this embodiment, the blocking member 11′ is an end plate forming an extension radially protruding from the shaft 3′ so that the shaft 3′ cannot fit to move through the first opening 6a′. The blocking member 9′ may be detachable but this is not necessary.

In the second embodiment, the fixing means 9′,11′,12′ comprise a blocking member 12′ for blocking rotation of the shaft 3′, which is mounted on the second supporting wall. The blocking member 12′ can be moved to an unblocking state, for which purpose it is in this case displaceably, in particular detachably, mounted on the second supporting wall 4b′. The blocking member 12′ for blocking rotation of the shaft 3′ extends into a recess formed in the shaft 3′, which recess is not rotationally symmetrical, whereby the rotation of the shaft 3′ is blocked. The recess is in this case not open in axial direction (towards the left in FIGS. 5-8) whereby the blocking member 12′ for blocking rotation of the shaft 3′ extends, in its blocking state, between two walls of the recess formed in the shaft 3′, and thereby blocks also axial movement of the shaft in both the first and second axial direction X₁,X₂. Accordingly, it serves also as a blocking means for blocking the second end b′ of the shaft 3′ from moving axially towards the first axial direction X₁ so that the second end b′ of the shaft 3′ retracts from the second opening 6b′ into the pulley space 5′. This is however not necessary as the recess could alternatively be formed to be open in the axial direction. On the other hand, when the rotation is blocked in the manner as illustrated, the blocking means 9′ are not necessary.

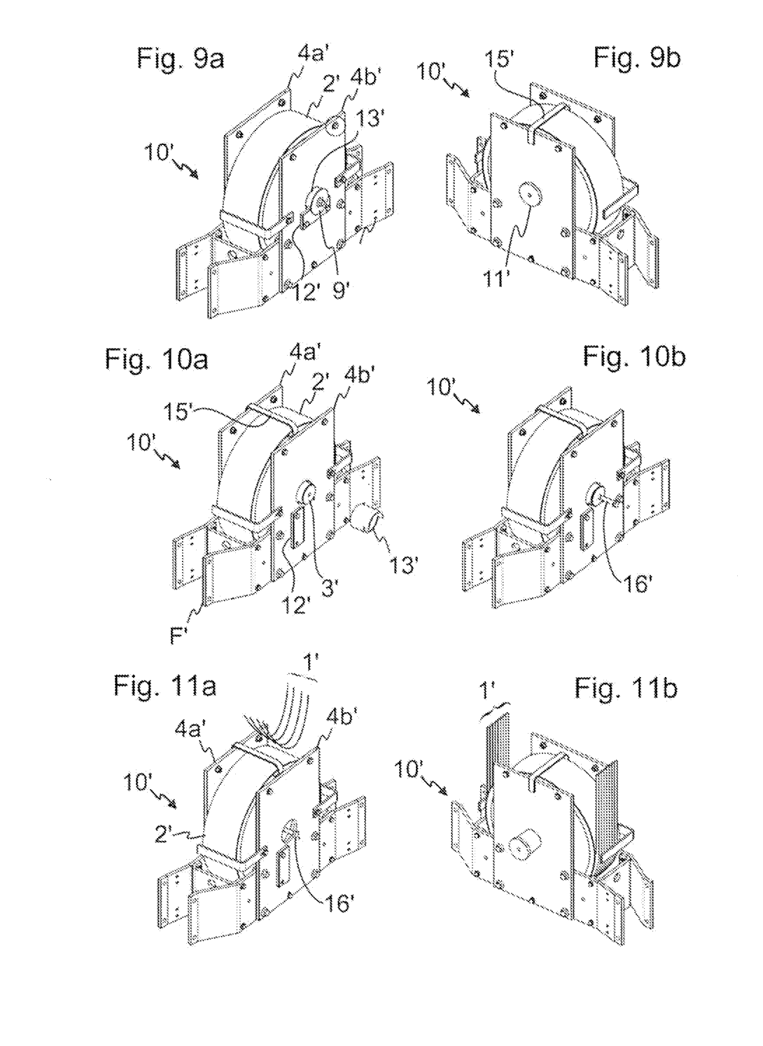

As mentioned, the pulley arrangement 10′ comprises a means 13′,14′ for blocking the pulley 2′ from moving axially in the pulley space 5′. Said means 13′,14′ for blocking the pulley 2′ from moving axially in the pulley space 5′ comprise around the second end b′ of the shaft 3′ a bushing 13′, one axial end of the bushing 13′ being supported in axial direction against an inner cylinder part 8′ of the bearing 2b′ and the other axial end extending into the second opening (6b′), the axial movement of the bushing 13′ in the second direction through the second opening 6b′ being blocked by at least one blocking member (9′ and/or 12′) of the fixing means 9′,12′, the bushing 13′ thereby blocking the inner cylinder part 8′ and thereby also the pulley body 2a′ from moving axially towards the second supporting wall 4b′, the blocking member (9′ and/or 12′) being movable into an unblocking state, e.g. by detaching it, and when the blocking member (9′ and/or 12′) is in the unblocking state the bushing 13′ can be moved through said second opening 6b′ out of the pulley space 5′, whereby the bushing 13′ can be moved out of way of the rope(s) 1′. As illustrated in FIGS. 6 to 7 in the method the blocking member (9′ and/or 12′) is moved in the unblocking state, in this case by detaching, after which the bushing 13′ is moved through said second opening 6b′ out of the pulley space 5′ whereby the bushing 13′ is moved out of way of the rope(s) 1′. As can be seen in the drawings 5-8 as well as in FIGS. 9-11 the bushing 13′ is preferably such that it has a cutout on the side thereof allowing the blocking member 12′ for blocking rotation of the shaft 3′ to extend into contact with the shaft 3′. On the opposite side of the pulley 2′, the axial movement of the pulley is blocked in a corresponding manner. Said means 13′,14′ for blocking the pulley 2′ from moving axially in the pulley space 5′ comprise around the first end a′ of the shaft 3′ a bushing 14′ one axial end of the bushing 14′ being supported against an inner cylinder part 8′ of the bearing 2b′ and the other axial end extending into the first opening 6a′, the axial movement of the bushing 14′ in the first direction through the first opening 6b′ being blocked by a blocking member 11′ of the fixing means 9′,11′,12′ whereby the inner cylinder part 8′ and thereby the pulley body 2a′ are blocked from moving axially towards the first supporting wall 4a′, when the pulley arrangement 10′ is in its assembled state as illustrated in FIG. 5.

It is preferable that the method relates to installing process of elevator ropes wherein said one or more ropes 1,1′ is/are guided to pass around said pulley 2,2′ while the pulley arrangement 10,10′ already forms part of a counterweight mounted in the elevator. Thereby, the pulley arrangement 10,10′ is installed in the elevator at the time the rope(s) 1,1′ are guided around the pulley 2,2′ thereof. Thereby, it is also preferable that the rope(s) is/are guided to pass around said pulley (2,2′) while the pulley frame is already mounted on or integral with the counterweight frame Fcw, Fcw′. In this way, the rope(s) of a new elevator can be installed, but also rope(s) of an existing elevator. In the latter case, the method is a method for replacing old ropes of an existing elevator (an elevator, which has been already in use). Then, the method further comprises before the rope(s) 1,1′ is/are moved in the transverse direction thereof) in the pulley space 5,5′ past the axial side of the pulley and the second end of the shaft; a step wherein the old rope(s) is/are moved in the transverse direction thereof in the pulley space 5,5′ past the axial side of the pulley and the second end of the shaft away from the pulley space 5,5′. FIGS. 9-11 illustrate further preferable details of the pulley arrangement 10′ as well as the method wherein the pulley arrangement 10′ is roped.

In FIG. 9a is illustrated the initial stage of the method as also illustrated in FIG. 5, the pulley arrangement 10′ being in assembled state. FIG. 9b shows the next step wherein a holding means 15′ is arranged to hold the pulley 2′ stationary relative to its frame F′. The holding means 15′ preferably comprises a bracket that is fixed on the frame F′, the bracket extending on an internal side of a flange of the pulley 2′ (not showed in details) whereby the pulley 2′ can rest on the bracket via the flange. After this, the blocking means 9′ is detached, the blocking member 12′ displaced from blocking position, the bushing 13′ removed through the second opening 6b resulting in the stage as illustrated in FIG. 10a. After this, a bolt 16′, serving as a pushing aid, is fixed on the end of the shaft 3′ resulting in the stage as illustrated in FIG. 10b. The pushing aid is then utilized by pushing it so that the shaft 3′ retracts from the opening 6b in the manner as defined elsewhere resulting in the stage as illustrated in FIG. 11a, the shaft resulting in position as illustrated in FIG. 6 (wherein the pushing aid is not illustrated though). After this, the bolt 16′ is detached from the shaft 3′. After this, the ropes 1′ are moved in the manner as defined elsewhere past axial side of the pulley as well as past the second end b′ of the shaft 3′ and further to pass around said pulley 2′ turning against and around its circumference, as illustrated in FIG. 11 b but also in FIGS. 3 and 7. After this, the bolt 16′ is fixed on the end of the shaft 3′, the bolt 16′ now serving as a pulling aid. The pulling aid is then utilized by pulling it so that the shaft 3′ penetrats back into the opening 6b′. After this the bushing 13′ is moved into its position around the shaft 3′ and therafter the fixing means 9′,11′,12′ are positioned to block the shaft 3′ from moving axially or from rotating, so that the shaft 3′ is fixed as illustrated in FIGS. 9a and 5. Thereby, the rope installation is completed. At least the details related to features 15′ and 16′ are as such preferable also with the pulley arrangement 10 as well as the method related to it.

When referring to an elevator, it is mean an elevator of the type meant for vertically transporting passengers and/or goods. The rope(s) 2,2′ is/are most preferably the suspension rope(s) for suspending the elevator car and/or the counterweight of the elevator.

As mentioned, in a preferred embodiment, the pulley arrangement 10,10 has, or at least is bringable to have, a free space on the axial side of the pulley sufficiently large to allow a rope 1,1′ to be moved transversely past the axial side of the pulley 1,1′ in the pulley space 5,5′. In particular, it is preferable, that the axial side of pulley 2,2′, i.e. the side of the pulley next to the second supporting wall 4b,4b′, is spaced apart from the second supporting wall 4b,4b′ sufficiently far that a rope 1,1′ can be moved transversely between them, alongside the axial side of the pulley 2,2′. This can be realized in the assembled state of the pulley arrangement 10,10′ whereby additional steps for making room on the axial side of the pulley 2,2′ are not necessary. Alternatively, the arrangement 10,10′ is bringable to this kind of state in which case the method comprises a step of arranging the pulley arrangement to this kind of state. A step to bring the pulley arrangement to this kind of state might comprise displacing components of the pulley arrangement, for example moving the pulley axially towards the first direction X₁ and/or displacing component(s) (e.g. components of the pulley arrangement 10,10′not showed in the simplified illustrations of FIGS. 1 to 11) reducing the clearance between the pulley 2,2′ and the second supporting wall 4b,4b′.

In the preferred embodiments as illustrated in FIGS. 1 to 11, the shaft 3,3′ extends through an opening of the pulley. It is preferable, but not necessary, that shaft 3,3′ is axially movable relative to the pulley 2,2′ in said the opening of the pulley 2,2′ as it is illustrated in FIGS. 1 to 11. This movability provides that the shaft 3,3′ can be moved a long way axially, independently of how great a clearance there is between the pulley 2,2′ and the first supporting wall. Thereby, the second end b,b′ of the shaft 3,3′ can extend through and well beyond the second opening 6b,6b′, if desired. In this way, the shaft 3,3′ can be more firmly supported by the frame F, F′ and fixing means 9,11,12;9′,11′,12′ can be positioned on the outside of the supporting wall(s). The pulley 2,2′, in particular the inner part 8,8′ of the bearing 2b,2b′, is then preferably mounted on the shaft 3,3′ axially movably and positioned axially by a means for blocking the pulley 2,2′ from moving axially in the pulley space 5,5′. In the embodiment of FIGS. 5 to 11 said means are in the form of the bushings 13′,14′, but also alternative solutions may be utilized. FIGS. 1 to 4 do not show means for blocking the pulley 2 from moving axially in the pulley space 5, but in this case said means could be any kind of means for releasably locking the inner bearing part 8 axially immovably on the shaft 3,3′.

The rope(s) 1,1′ referred to in the application may be round in cross section as illustrated but may be alternatively of any other type, such as in the form of a belt.

It is to be understood that the above description and the accompanying Figures are only intended to illustrate the present invention. It will be apparent to a person skilled in the art that the inventive concept can be implemented in various ways. The invention and its embodiments are not limited to the examples described above but may vary within the scope of the claims.

1. A method for installing one or more ropes of an elevator, wherein a pulley of a pulley arrangement is roped, which pulley arrangement comprises
a pulley having a shaft for mounting it rotatably on a support frame, the shaft having a first end and a second end; and
a support frame having a first supporting wall and a second supporting wall spaced apart and having a pulley space between them, in which pulley space the pulley is mounted, the first end of the shaft extending into a first opening of the first supporting wall, and the second end of the shaft extending into a second opening of the second supporting wall,
in which method one or more ropes is/are guided to pass around said pulley, wherein in the method
a free space is arranged on the axial side of the pulley and the second end of the shaft sufficiently large to allow a rope to be moved transversely past the axial side of the pulley and past the axial side of the second end of the shaft in the pulley space, said step comprising at least enabling axial movement of the shaft, and thereafter moving the shaft axially so that the second end of the shaft retracts from the second opening into the pulley space; and
said rope(s) is/are moved in the transverse direction thereof in the pulley space past the axial side of the pulley and past the axial side of the second end of the shaft; and
the shaft is moved axially so that the second end of the shaft penetrates back into the second opening; and
the shaft is fixed at least axially immovable.

2. A method according to claim 1, wherein said rope(s) is/are guided to pass around said pulley while the pulley arrangement already forms part of a counterweight mounted in the elevator.

3. A method according to claim 1, wherein said one or more ropes is/are guided to pass around said pulley while the pulley frame is already mounted on or integral with the counterweight frame.

4. A method according to claim 1, wherein the method is a method for replacing old ropes of an existing elevator, which method further comprises a step wherein the old rope(s) is/are moved in the transverse direction thereof in the pulley space past the axial side of the pulley and past the axial side of the second end of the shaft away from the pulley space.

5. A method according to claim 1, wherein the fixing means comprise at least one blocking member blocking the second end of the shaft from moving axially so that the second end of the shaft retracts from the second opening into the pulley space, which at least one blocking member is movable into an unblocking position, and in the method the fixing means are released to allow axial movement of the shaft by moving the at least one blocking member into an unblocking position, e.g. by displacing, preferably detaching, the at least one blocking member from the second end of the shaft.

6. A method according to claim 1, wherein the arrangement comprises means for blocking the pulley from moving axially in the pulley space, which means comprise around the second end of the shaft a bushing, one axial end of the bushing being supported in axial direction against an inner cylinder part of the bearing and the other axial end extending into the second opening, the axial movement of the bushing through the second opening being blocked by a blocking member of the fixing means, the bushing thereby blocking the inner cylinder part and thereby also the pulley body from moving axially towards the second supporting wall, the blocking member being movable into an unblocking state, e.g. by detaching it, and when the blocking member is in the unblocking state the bushing can be moved through said second opening out of the pulley space, and in the method the blocking member is moved into the unblocking state, after which the bushing is moved through said second opening out of the pulley space whereby the bushing is moved out of way of the rope(s).

7. A pulley arrangement of an elevator, which pulley arrangement comprises
a pulley having a shaft for mounting it rotatably on a support frame, the shaft having a first end and a second end; and
a support frame having a first supporting wall and a second supporting wall spaced apart and having a pulley space between them, in which pulley space the pulley is mounted, the first end of the shaft extending into a first opening of the first supporting wall, and the second end of the shaft extending into a second opening of the second supporting wall; and
fixing means for fixing the shaft at least axially immovable, which fixing means are releasable to allow axial movement of the shaft,
wherein when the fixing means are in their released state, the shaft is axially movable in the first and second opening such that the second end of the shaft retracts from the second opening into the pulley space such that a free space is formed on the axial side of the second end of the shaft sufficiently large to allow a rope to be moved transversely past the axial side of the second end of the shaft in the pulley space.

8. A pulley arrangement according to claim 7, wherein the arrangement is bringable into a state where a free space exists on the axial side of the pulley and on the axial side of the second end of the shaft sufficiently large to allow a rope to be moved transversely past the axial side of the pulley and past the axial side of the second end of the shaft in the pulley space.

9. A pulley arrangement according to claim 7, wherein the pulley arrangement has, or at least is bringable to have, a free space on the axial side of the pulley sufficiently large to allow a rope to be moved transversely past the axial side of the pulley in the pulley space.

10. A pulley arrangement according to claim 7, wherein the fixing means comprise at least one blocking member, preferably on the second end of the shaft, for blocking the second end of the shaft shaft from moving axially so that the second end of the shaft retracts from the second opening into the pulley space, which at least one blocking member is movable into an unblocking position so as to release the fixing means to allow axial movement of the shaft, e.g. by displacing, preferably detaching, the at least one blocking member from the second end of the shaft.

11. A pulley arrangement according to claim 7, wherein the fixing means comprises a blocking member for blocking rotation of the shaft.

12. A pulley arrangement according to claim 7, wherein the pulley comprises a bearing via which the pulley body is supported on the shaft.

13. A pulley arrangement according to claim 12, wherein the bearing has an outer cylinder part in fixed connection with the body of the pulley and an inner cylinder part rotatable within the outer cylinder part inside on which inner cylinder part the shaft is mounted.

14. A pulley arrangement according to claim 7, wherein the pulley arrangement comprises a means for blocking the pulley from moving axially in the pulley space.

15. A pulley arrangement according to claim 7, wherein said means for blocking the pulley from moving axially in the pulley space comprise around the second end of the shaft a bushing, one axial end of the bushing supported in axial direction against an inner cylinder part of the bearing and the other axial end extending into the second opening, the axial movement of the bushing in the second direction through the second opening being blocked by a blocking member of the fixing means, the bushing thereby blocking the inner cylinder part and thereby also the pulley body from moving axially towards the second supporting wall, the blocking member being movable into an unblocking state, e.g. by detaching it, and when the blocking member is in the unblocking state the bushing can be moved through said second opening out of the pulley space, whereby the bushing can be moved out of way of the rope(s).
